(19) United States
(12) Patent Application Publication
(10) Pub. No.: US 2025/0296788 A1
(43) Pub. Date: Sep. 25, 2025

(54) CONVEYING SYSTEM, TREATMENT SYSTEM AND METHOD FOR TREATING WORKPIECES

(71) Applicant: DÜRR SYSTEMS AG, Bietigheim-Bissingen (DE)

(72) Inventors: Michael LAUER, Bietigheim-Bissingen (DE); Klaus HEINSOHN, Weil der Stadt (DE); Tobias JÄGER, Karlsruhe (DE)

(21) Appl. No.: 18/720,434

(22) PCT Filed: Dec. 15, 2022
(86) PCT No.: PCT/DE2022/100960

§ 371 Date: Jun. 14, 2024

(30) Foreign Application Priority Data
Dec. 22, 2021 (DE) 10 2021 214 914.6

(51) Int. Cl. B65G 49/04

(52) U.S. Cl. CPC B65G 49/049; B65G 2201/0294

(57) ABSTRACT

The aim of the invention is to provide a conveying system for conveying workpieces, in particular vehicle bodies, which has a simple design and enables in particular an efficient workpiece conveyance for optimized workpiece treatment. In order to achieve said aim, it is proposed that the conveying system comprises a main conveying device, a lifting device and a transfer device.

### RELATED APPLICATIONS

This application is a national phase of international application No. PCT/DE2022/100960 filed on Dec. 15, 2022, and claims the benefit of German application No. 10 2021 214 914.6 filed on Dec. 22, 2021, which are incorporated herein by reference in their entirety and for all purposes.

### FIELD OF DISCLOSURE

The present disclosure relates to a conveying system for conveying workpieces. The conveying system is particularly suitable for conveying vehicle bodies in the production of vehicles, in particular motor vehicles, for example passenger cars.

### BACKGROUND

Vehicle bodies are typically coated, for example in a dip-painting process. Here, according to conventional methods, linear throughput processes are provided. For example, vehicle bodies are guided through a treatment container along a conveying direction in order to carry out a coating process. However, such a line treatment can be disadvantageous in terms of the often desired flexibility in workpiece treatment.

Therefore, examples disclosed herein are based on the object of providing a conveying system that has a simple design and enables in particular an efficient workpiece conveyance for optimized workpiece treatment.

### SUMMARY

According to examples disclosed herein, this object is achieved by a conveying system with the features of claim 1.

The conveying system is used to convey workpieces, in particular vehicle bodies, for example motor vehicles, in particular passenger cars.

The conveying system preferably comprises the following:
a main conveying device for conveying the workpieces along a main conveying direction;
a lifting device by means of which the workpieces can be raised and/or lowered at a position arranged laterally offset next to the main conveying device;
a transfer device by means of which the workpieces can be transferred from the main conveying device to the lifting device and/or from the lifting device to the main conveying device in a transfer direction extending transversely to the main conveying direction.

As the conveying system comprises a lifting device by means of which the workpieces can be raised and/or lowered laterally offset next to the main conveying device, the workpieces can preferably be treated independently of the conveyance of the same along the main conveying direction. In particular, this can preferably provide a decoupling of the conveyance along the main conveying direction, on the one hand, and a treatment at one of the positions accessible by means of the lifting device, on the other hand.

It can be advantageous if the workpieces can be lowered into a treatment position by means of the lifting device. Preferably, the workpieces can be lowered by means of the lifting device into a fluid container, in particular an immersion tank, and can thereby be immersed in a liquid arranged in the fluid container, in particular in the immersion tank.

In particular, a treatment position is arranged laterally offset next to the main conveying device.

The lifting device preferably comprises one or more, for example two or four, lifting units, which are preferably each provided with one or more lifting elements.

A lifting unit is, in particular, a lifting column device by means of which a vertical movement for raising and/or lowering the workpieces can be realized.

Each lifting element preferably engages directly or indirectly with the workpiece to move the workpiece. For example, one or more substantially L-shaped lifting elements are provided, which engage under the workpiece and can be moved, in particular in a vertical direction, by displacing the lifting elements along the lifting units.

It can be advantageous if one or more lifting elements, in particular all lifting elements, are guided or can be guided within intermediate regions between two electrodes in each case. For example, it may be provided that a plurality of electrodes are arranged in the fluid container and project away from a side wall of the fluid container. At least one portion of each lifting element extending substantially in a vertical direction then preferably does not project further away from the side wall into an interior space of the fluid container than the adjacently arranged electrodes.

With one configuration, it may be provided that the lifting device comprises only two lifting units, which, in particular, are arranged on one and the same side of a fluid container.

Alternatively, it may be provided that the lifting device comprises four lifting units, wherein two lifting units are arranged on opposite sides of the fluid container in each case.

In addition, it may be alternatively provided that exactly two lifting units are provided, which are arranged on opposite sides of the fluid container and are diagonally opposite one another with respect to the fluid container.

In a further configuration, it may be provided that the lifting device comprises a suspension device.

In particular, the suspension device comprises a holding frame, which forms lifting elements of the lifting device.

In addition, the suspension device preferably comprises one or more push and/or pull elements, for example belts, push and/or pull cylinders or chains, in particular push chains, which in particular can be driven by an electric motor in order to raise and/or lower the holding frame together with a workpiece arranged thereon.

It can be advantageous if the main conveying device is a transverse conveying device by means of which the workpieces can be conveyed in a transverse alignment of the same.

The workpieces are preferably oriented in the transverse alignment in such a way that a longitudinal direction, in particular a longitudinal axis, of the workpieces is aligned transversely, in particular at least approximately perpendicularly, to the main conveying direction and/or at least approximately horizontally.

In particular, if the workpieces are designed as vehicle bodies, it may be provided that vehicle longitudinal axes of the vehicle bodies are aligned transversely, in particular at least approximately perpendicularly, to the main conveying direction and/or at least approximately horizontally, if the workpieces designed as vehicle bodies are arranged in the transverse alignment.

It may be provided that the main conveying device is a chain conveying device or a roller conveying device or an overhead conveying device. Furthermore, it may be provided that the main conveying device comprises a chain conveying device and/or a roller conveying device and/or an overhead conveying device.

It can be advantageous if the workpieces are arranged on the respective conveying device, in particular the main conveying device, the lifting device and/or the transfer device, by means of workpiece carriers.

For example, it may be provided that the main conveying device comprises a plurality of carriages for holding the workpiece carriers and/or the workpieces. For example, each carriage can comprise a drip tray for collecting dripping fluid, in particular cleaning fluid and/or treatment fluid.

It can be advantageous if the main conveying device is a rail conveyor and the carriages can be moved on rails of the rail conveyor along the main conveying direction.

It may be provided that the transfer device is formed by one or more chain conveying devices or by one or more roller conveying devices. Furthermore, it may be provided that the transfer device comprises one or more chain conveying devices and/or one or more roller conveying devices.

It may be provided that the transfer device is made up of several parts, in particular that it comprises a plurality of conveying device portions. A conveying device portion can, for example, be arranged on the main conveying device or assigned thereto. In particular, this is a telescopic device and/or is formed by drivable rollers and/or chains.

A conveying device portion, in particular a further conveying device portion, can, for example, be arranged on the lifting device or assigned thereto. Here, for example, a configuration in the form of driven rollers and/or chains can be provided.

The conveying device portion of the transfer device assigned to the main conveying device is, in particular, arranged movably along the main conveying device and/or assigned to a respective carriage of the main conveying device or arranged thereon.

A conveying device portion of the transfer device assigned to the lifting device is preferably arranged and/or designed to be stationary on the respective lifting device. Here, stationary is to be understood in particular to mean that this conveying device portion is not moved from the respective lifting device to another lifting device.

It can be advantageous if the conveying system comprises a plurality of lifting devices arranged in succession along the main conveying direction by means of which the workpieces can be raised and/or lowered at a plurality of positions arranged laterally offset next to the main conveying device, in particular can be lowered into a plurality of treatment positions that are different from one another.

Each lifting device is preferably assigned such a position, in particular such a treatment position. Preferably, each lifting device is assigned exactly one such position, in particular exactly one such treatment position.

In one configuration of examples disclosed herein, it may be provided that the transfer device comprises one or more carrying units onto which the workpieces can be placed directly or indirectly, in particular by means of a workpiece carrier, for example by means of a traverse and/or a skid.

The workpieces can be transferred, for example placed, in particular by horizontally displacing thereof starting from the main conveying device to the one or more carrying units of the transfer device.

It can be advantageous if one or more of the carrying units can be moved. In particular, it may be provided that one or more, in particular all, of the carrying units are linearly displaceable in a direction transverse to the transfer direction.

The transfer device preferably comprises a plurality of carrying units, in particular two rows of carrying units, which can be moved towards one another to reach a carrying position of the carrying units and/or which can be moved away from one another to reach a release position.

In the carrying position of the carrying units, the carrying units are preferably arranged in such a way that a workpiece, possibly together with a workpiece carrier, can be arranged thereon and/or can be transferred from the main conveying device or to the main conveying device.

In the release position of the carrying units, they are preferably arranged in such a way that they do not get in the way of a lifting movement of the workpiece, in particular raising and/or lowering thereof by means of the lifting device.

In the carrying position of the carrying units, these preferably protrude into the lifting path of the workpiece.

In the carrying position thereof, the carrying units preferably engage an underside of the workpiece and/or an underside of a workpiece carrier thereof.

The workpieces can preferably be lifted from the one or more carrying units by means of the lifting device, in particular by means of one or more lifting elements of the lifting device, in order to release the carrying units themselves and thus to be able to move them from the carrying position to the release position.

It may be provided that the treatment position, into which the workpieces can be lowered by means of the lifting device, is arranged below the one or more carrying units of the transfer device with respect to the direction of gravity.

In particular, it may be provided that the workpiece can be lowered completely into a region arranged below the one or more carrying units in order to reach the position, in particular the treatment position.

The conveying system is particularly suitable for use in a treatment system for treating workpieces, in particular vehicle bodies, for example in the production of motor vehicles, in particular passenger cars.

Therefore, examples disclosed herein also relate to a treatment system for treating workpieces, wherein the treatment system preferably comprises one or more conveying systems according to examples disclosed herein.

By means of the treatment system, in particular an immersion treatment can be carried out.

Therefore, the treatment system preferably comprises one or more treatment stations, wherein an immersion tank is preferably arranged at each treatment station.

The workpieces can preferably be immersed in the respective immersion tank by means of one or more lifting devices of the conveying system.

Preferably, a separate immersion tank, in particular a single immersion tank, is assigned to each treatment station.

However, it may also be provided that an immersion tank is provided which extends over a plurality of treatment stations, in which case in particular a plurality of lifting devices are provided in order to be able to arrange the workpieces at different positions in the immersion tank, in particular to be able to lower them into the immersion tank at different points.

By means of the lifting device of each treatment station, the respective workpiece can preferably be lowered linearly along the direction of gravity and raised against the direction of gravity.

The one or more immersion tanks of the one or more treatment stations, in particular all of the immersion tanks, are preferably arranged below a conveying level at which the workpieces can be conveyed along the main conveying direction by means of the main conveying device.

To carry out a treatment step by means of the treatment system, it is therefore preferably only necessary to move the workpieces at least approximately horizontally from the main conveying device to the lifting device and—with the exception of a preferably slight raising of the workpieces—to lower the workpieces vertically into the respective immersion tank.

A partial rotation of the workpieces can be provided, for example, to avoid the formation of bubbles upon immersion. However, a complete rotation of the workpieces is preferably not necessary.

One or more of the treatment stations, in particular all of the treatment stations, are preferably electro dip coating stations. Alternatively or additionally, it may be provided that one or more of the treatment stations, in particular all of the treatment stations, are cleaning stations and/or pre-treatment stations.

It can be advantageous if one or more of the treatment stations, in particular all treatment stations, are only accessible from one side and/or only starting from the main conveying device, in particular in order to feed and/or discharge workpieces.

The treatment stations, in particular the lifting devices, are then preferably not continuous stations, but rather are designed as boxes.

Examples disclosed herein are also based on the object of providing a method for treating workpieces, with which efficient workpiece conveyance is provided.

According to examples disclosed herein, this object is achieved by a method according to the independent method claim.

The method for treating workpieces comprises, in particular, the following:
Conveying of the workpieces by means of a main conveying device along a main conveying direction;
Transferring of the workpieces by means of a transfer device in a transfer direction extending transversely to the main conveying direction from the main conveying device to a lifting device and/or from the lifting device to the main conveying device;
Raising and/or lowering the workpieces by means of a lifting device at a position arranged laterally offset next to the main conveying device, wherein the workpieces are lowered into a treatment position in particular.

The method according to examples disclosed herein preferably has individual or several of the features and/or advantages described in connection with the conveying system according to examples disclosed herein and/or the treatment system according to examples disclosed herein.

Furthermore, the treatment system according to examples disclosed herein and/or the conveying system according to examples disclosed herein preferably has individual or several of the features and/or advantages described in connection with the method according to examples disclosed herein.

It can be advantageous if the workpieces are picked up directly or indirectly by means of one or more carrying units of the transfer device and made available to the lifting device. The one or more carrying units are preferably moved away by the lifting device after the respective workpiece has been picked up, in particular moved out of a lifting path of the respective workpiece arranged directly below the workpiece.

It can also be advantageous if the workpieces are moved in a transverse alignment thereof along the main conveying direction and in a longitudinal alignment thereof along the transfer direction.

Since the direction of movement along the main conveying direction is in particular at least approximately perpendicular to the direction of movement along the transfer direction, there is preferably no change in the alignment of the workpieces, in particular no rotation thereof (with the exception of conceivable tilting to facilitate immersion and/or emersion and/or to avoid the formation of bubbles), during the entire conveying process by means of the main conveying device and/or the transfer device and/or the lifting device.

Furthermore, the conveying system, the treatment system and/or the method may have one or more of the following features and/or advantages:

Carrying units of adjacent treatment stations are preferably arranged offset to one another in such a way that they cannot block one another in their respective movement and thus a distance between the fluid containers can be minimized.

It can be advantageous if a region accessible to people, in particular a maintenance region, is formed above the carrying units.

To optimize the treatment, provision can be made in particular for rinsing or spraying the workpieces upon emersion from the respective fluid container. For example, nozzles can be provided on an upper tank edge of the fluid container or in the region of the upper tank edge of the fluid container. In particular, ultrafiltrate of a treatment medium can be used as a rinsing or spraying medium.

It can be advantageous if the lifting device comprises a swivel device for swiveling the workpieces, in particular for optimizing the immersion or emersion process. In particular, the swivel device can be a pendulum device with a plurality of pendulum arms, which are mechanically or electrically coupled to one another, preferably to achieve a desired swivel movement and/or to limit a maximum swivel movement.

It can be advantageous if one or more of the pendulum arms extend at least in portions between two electrodes in each case, in particular also while the workpiece is swiveling or maintaining a swivel position. An intermediate space between the electrodes is thus preferably used to hold the one or more pendulum arms at least partially, as a result of which a smaller width of the fluid container can preferably be realized.

A swivel movement of the workpiece is preferably limited so that the pendulum arms do not come into contact with the electrodes.

Further preferred features and/or advantages of examples disclosed herein form the subject matter of the following description and the drawings illustrating exemplary embodiments.

### BRIEF DESCRIPTION OF THE DRAWINGS

FIG. 1 is a schematic perspective representation of a first embodiment of a treatment system, in which a conveying system with a main conveying device and a transfer device for transfer to a lifting device are provided, wherein the lifting device is provided with two lifting units on one side;

FIG. 2 is an enlarged representation of a section of the main conveying device together with a workpiece arranged thereon;

FIG. 3 is a schematic vertical longitudinal section through an immersion tank of the treatment system of FIG. 1, wherein a workpiece is immersed in this immersion tank by means of the lifting device;

FIG. 4 is a schematic perspective representation of a second embodiment of a treatment system corresponding to FIG. 1, in which a lifting device with two lifting units on each side is provided in each case;

FIG. 5 is a schematic perspective representation of a third embodiment of a treatment system, in which a lifting device with two lifting units arranged diagonally opposite one another is provided;

FIG. 6 is a schematic perspective representation of a fourth embodiment of a treatment system, in which a lifting unit of the lifting device designed as a suspension is provided;

FIG. 7 is a schematic perspective representation of a fifth embodiment of a treatment system, in which the transfer device is designed as a chain conveyor, wherein a workpiece is currently transferred from the main conveying device to the lifting device;

FIG. 8 is a schematic representation of the fifth embodiment of the treatment system corresponding to FIG. 7, wherein the workpiece is lowered into an immersion tank by means of the lifting device;

FIG. 9 is an enlarged representation of the main conveying device of the fifth embodiment of the treatment system according to FIG. 7, wherein the workpiece is arranged in a position on the main conveying device in which the conveyance of the workpiece is effected along the main conveying direction; and

FIG. 10 is a schematic perspective representation of the main conveying device and the workpiece corresponding to FIG. 9, wherein the workpiece has been moved in the direction of the lifting device by means of a telescopic device in order to transfer the workpiece from the main conveying device to the lifting device.

The same or functionally equivalent elements are provided with the same reference signs in all figures.

### DETAILED DESCRIPTION

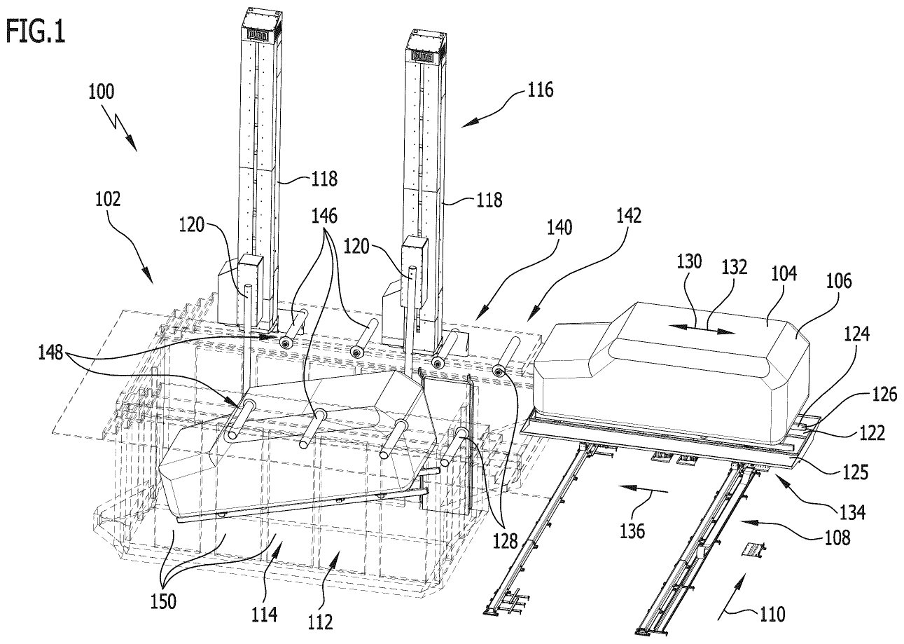

A first embodiment, shown in FIGS. 1 to 3, of a treatment system designated 100 as a whole comprises one or more treatment stations 102 for treating workpieces 104, in particular vehicle bodies 106.

In particular, the treatment system 100 is used to apply a coating to the workpieces 104.

In particular, a plurality of treatment stations 102 are provided for this purpose, which are designed in particular as electro dip coating stations.

In the figures, only a single treatment station 102 is shown for each treatment system 100. In fact, the treatment system 100 preferably comprises a plurality of, in particular at least approximately identically designed, treatment stations 102.

The treatment system 100 comprises a main conveying device 108 by means of which the workpieces 104 can be conveyed along a main conveying direction 110.

The treatment stations 102 are arranged laterally offset next to the main conveying device 108 and, in particular, are arranged in succession along the main conveying direction 110.

In the following, an individual one of the treatment stations 102 according to the figures is described in more detail. It is understood by a person skilled in the art that the further treatment stations 102 are functionally designed accordingly and that the main conveying device 108 is used, in particular, to transport the workpieces 104 along the main conveying direction 110 in order to selectively introduce the workpieces 104 individually or successively into a plurality of the treatment stations 102.

A treatment station 102 comprises a fluid container 112, in particular an immersion tank 114, into which the workpiece 104 can be introduced. For this purpose, the treatment station 102 comprises a lifting device 116 for raising and lowering the respective workpiece 104.

The lifting device 116 comprises one or more, for example two, lifting units 118 which are each provided with one or more lifting elements 120.

The lifting unit 118 is, in particular, a lifting column device by means of which a vertical movement for raising and/or lowering the workpieces 104 can be realized.

Each lifting element 120 directly or indirectly engages the workpiece 104 to move the workpiece 104. For example, substantially L-shaped lifting elements 120 are provided, which engage under the workpiece 104 and can be moved, in particular in the vertical direction, by displacing the lifting elements 120 along the lifting units 118.

In particular, the main conveying device 108 is a chain conveyor or rail conveyor or roller conveyor. In the embodiment shown in FIGS. 1 to 3, the main conveying device 108 is a rail conveyor.

The main conveying device 108 comprises one or more carriages 122 each for holding one or more workpieces 104.

For example, each carriage 122 may comprise a drip tray 125 in order to collect fluid dripping from the workpieces 104 and minimize contamination of the surrounding area.

The carriage 122 can pick up the workpieces 104 directly. Alternatively, for example, it may be provided that the carriage 122 is used to hold a workpiece carrier 124, for example a skid 126. The workpiece 104 is then arranged on the workpiece carrier 124.

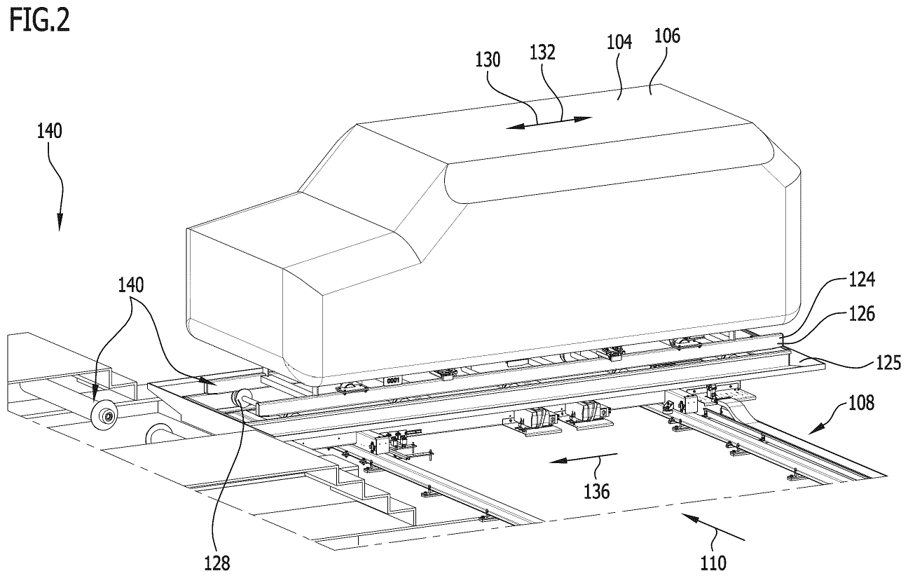

The carriage 122 of the main conveying device 108 comprises, in particular, a roller conveying device 128 shown in FIG. 2.

The workpiece carrier 124 or the workpiece 104 directly is mounted on this roller conveying device 128. The roller conveying device 128 is aligned such that the workpiece 104 can be moved in a transverse direction 130 of the main conveying device 108, which is aligned transverse to the main conveying direction 110.

The transverse direction 130 is aligned in particular perpendicular to the main conveying direction 110 and at least approximately horizontal.

The transverse direction 130 of the main conveying device 108 is preferably aligned substantially parallel to a longitudinal direction 132 of the workpiece 104.

The workpiece 104 is thus arranged in a transverse alignment on the main conveying device 108 and can be conveyed in this transverse alignment along the main conveying direction 110.

The main conveying device 108 is thus a transverse conveying device 134.

The transverse direction 130 is also a transfer direction 136, along which the workpiece 104 can be moved in order to transfer it from the main conveying device 108 to the lifting device 116.

The treatment system 100 preferably comprises a transfer device 140 by means of which the transfer from the main conveying device 108 to the lifting device 116 and from the lifting device 116 to the main conveying device 108 is effected.

The main conveying device 108, the transfer device 140 and the lifting device 116 thus operate together to convey the workpieces 104 in the treatment system 100.

Together, the main conveying device 108, the transfer device 140 and the lifting device 116 form a conveying system 142 of the treatment system 100.

The transfer device 140 is formed in two parts, wherein one conveying device portion 144 of the transfer device 140 is associated with the main conveying device 108 and another conveying device portion 144 is associated with the lifting device 116.

The conveying device portion 144 of the transfer device 140 associated with the main conveying device 108 is, in particular, formed by the roller conveying device 128 on the respective carriage 122 of the main conveying device 108.

The conveying device portion 144 associated with the lifting device 116 is formed, for example, by a further roller conveying device 128, which in particular is arranged substantially stationary at the treatment station 102.

This roller conveying device 128 associated with the lifting device 116 comprises or forms, in particular, a plurality of carrying units 146, which are provided, for example, with rollers and are used to displaceably hold the workpieces 104 and/or the workpiece carriers 124.

In particular, the carrying units 146 are designed in the form of two opposing rows 148 of carrying units 146.

The two rows 148 of carrying units 146 are movable relative to one another, in particular towards one another and away from one another.

In the position of the rows 148 of carrying units 146 shown in FIG. 1, the latter are arranged in a release position and, in particular, are positioned at a maximum distance from one another.

This release position is used in particular to release a lifting path for lowering the workpiece 104 into the immersion tank 114.

For taking over workpieces 104 from the main conveying device 108 and for transferring the workpieces 104 to the main conveying device 108, the rows 148 of carrying units 146 can be moved towards one another, so that the workpieces 104 can be placed on the carrying units 146, if necessary by means of the workpiece carriers 124, and can thus be transferred, in particular by a suitable drive of the rollers arranged on the carrying units 146. The rollers of the roller conveying devices 128 are preferably driven by one or more mechanical couplings, in particular to avoid an arrangement of electronic components in the regions of the treatment station 102 and/or the main conveying device 108 that may be exposed to liquid.

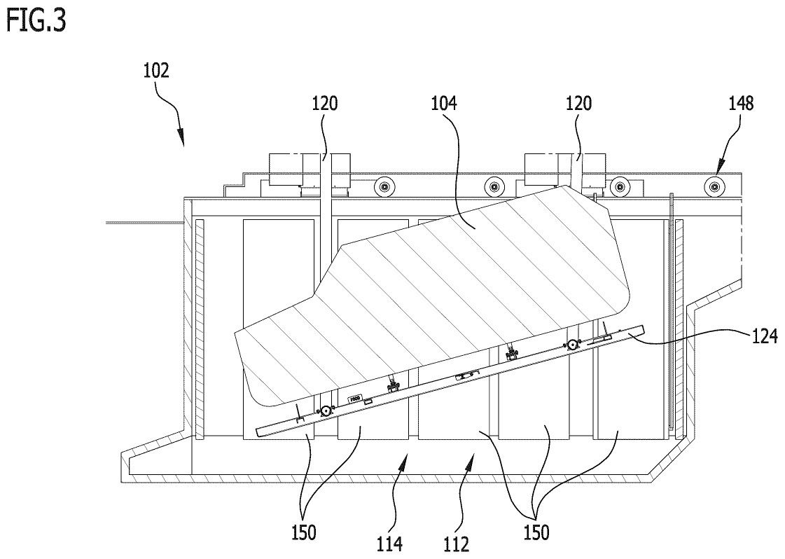

As can be seen in FIG. 1 and FIG. 3, a plurality of electrodes 150 are arranged in the fluid container 112, in particular in the immersion tank 114. The electrodes are used to apply an electric current to the workpieces 104, as a result of which in particular an electrodeposition process for coating the workpieces 104 can be carried out.

As can be seen in particular from FIG. 3, the electrodes 150 are preferably arranged in a manner distributed in the fluid container 112 in such a way that the lifting elements 120 can be introduced into the fluid container 112 between two electrodes 150 in each case in order to disturb an electric field formed by means of the electrodes 150 as little as possible.

In the embodiment of the treatment system 100 shown in FIGS. 1 to 3, the lifting device 116 comprises only two lifting units 118, which are arranged on the same side of the fluid container 112.

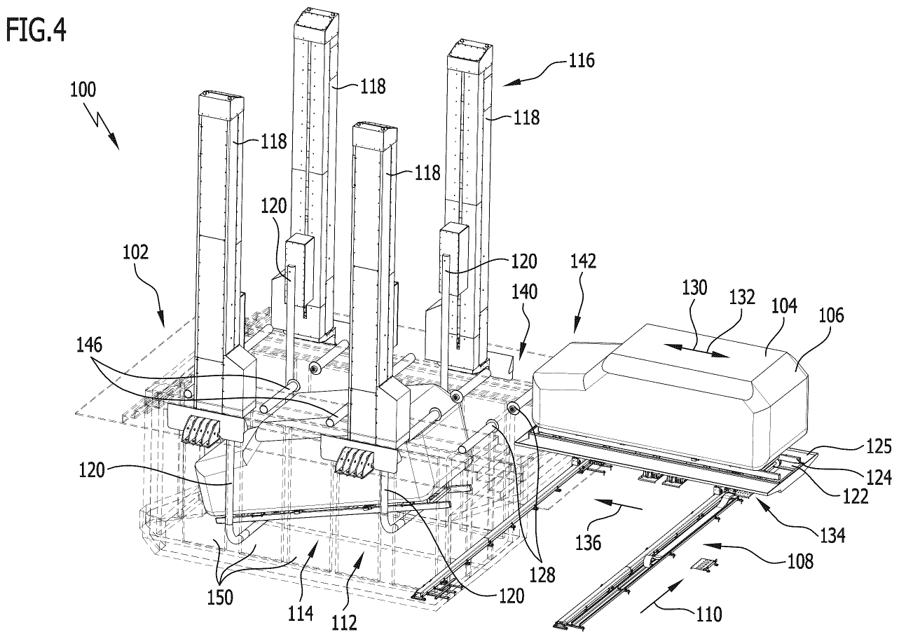

A second embodiment of a treatment system 100 shown in FIG. 4 differs substantially from the first embodiment shown in FIGS. 1 to 3 in that the lifting device 116 comprises four lifting units 118, wherein two lifting units 118 are arranged on opposite sides of the fluid container 112 in each case.

In all other respects, the second embodiment of the lifting device 116 shown in FIG. 4 corresponds to the embodiment shown in FIGS. 1 to 3 in terms of design and function, so that reference is made in this respect to their description above.

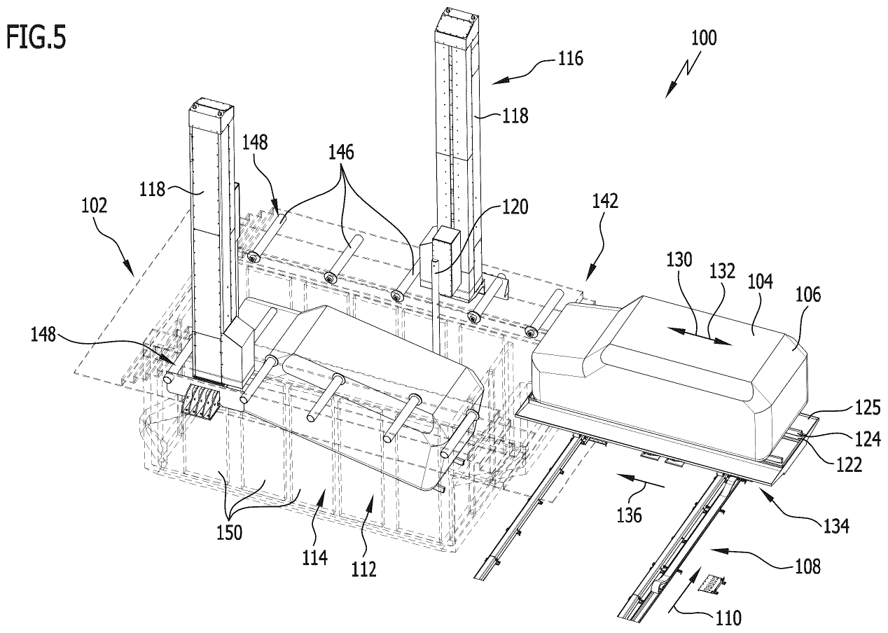

A third embodiment of the treatment system 100 shown in FIG. 5 differs substantially from the embodiment shown in FIGS. 1 to 3 in that the two lifting units 118 are arranged on opposite sides of the fluid container 112. In addition, the lifting units 118 are arranged offset to one another with respect to the transverse direction 130.

The lifting units 118 are arranged diagonally opposite one another, in particular with respect to the fluid container 112.

In all other respects, the third embodiment shown in FIG. 5 corresponds to the first embodiment shown in FIGS. 1 to 3 in terms of design and function, so that reference is made in this respect to their description above.

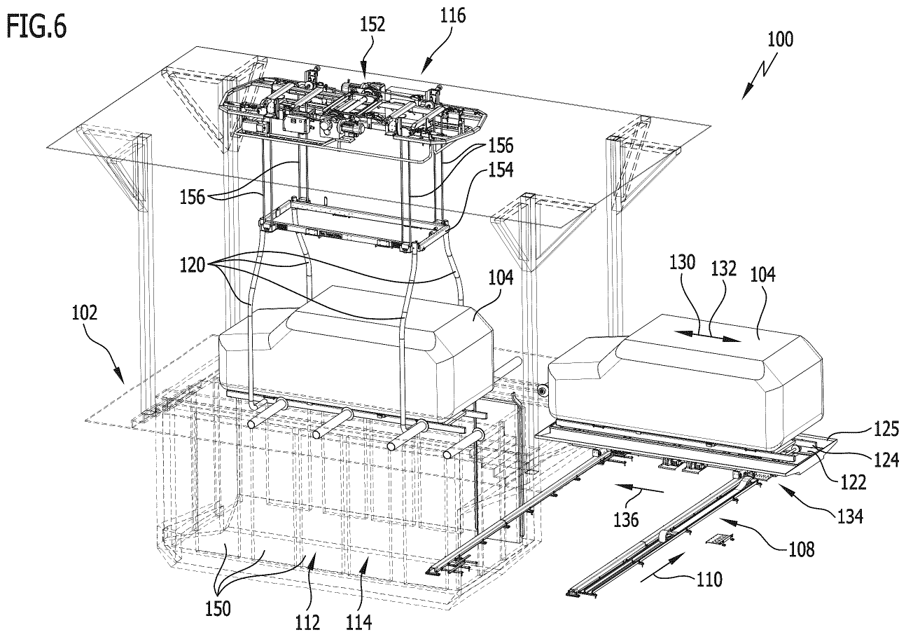

A fourth embodiment of the treatment system 100 shown in FIG. 6 differs substantially from the first embodiment shown in FIGS. 1 to 3 in that the lifting device 116 comprises a suspension device 152 instead of lifting units 118 designed as lifting column units.

In particular, the suspension device 152 comprises a holding frame 154, which forms the lifting elements 120 of the lifting device 116.

In addition, the suspension device 152 comprises one or more belts 156, which in particular can be driven by an electric motor in order to be able to raise and/or lower the holding frame 154 together with a workpiece 104 arranged thereon.

Instead of a belt 156, chains or other pull elements are also conceivable.

In all other respects, the fourth embodiment of the treatment system 100 shown in FIG. 6 corresponds to the embodiment shown in FIGS. 1 to 3 in terms of design and function, so that reference is made in this respect to their description above.

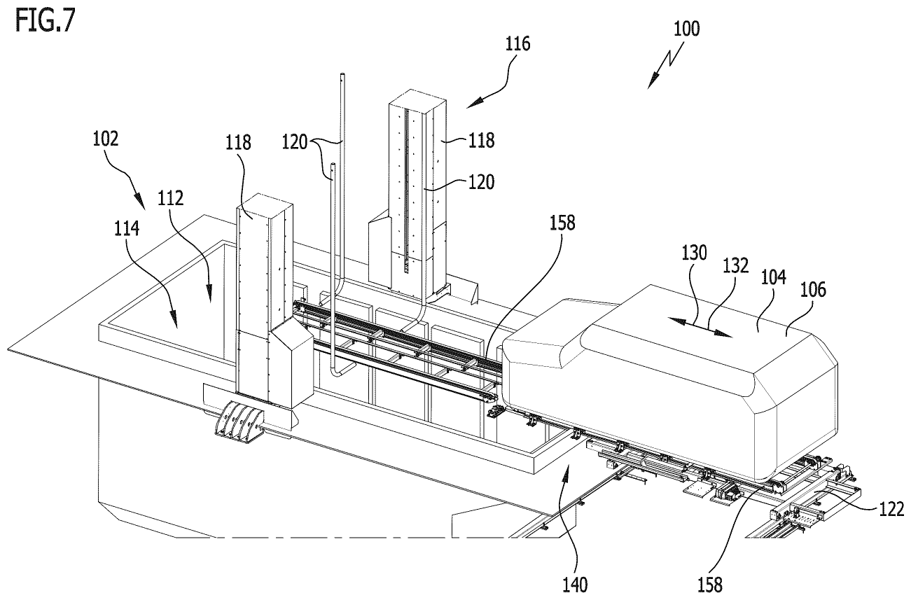

A fifth embodiment of a treatment system 100 shown in FIGS. 7 to 10 differs substantially from the embodiment shown in FIGS. 1 to 3 in that the transfer device 140 is formed by two chain conveying devices 158.

Here, a chain conveying device 158 is associated with the main conveying device 108 and, in particular, is arranged on a respective carriage 122 of the main conveying device 108. A further chain conveying device 158 is associated with the lifting device 116.

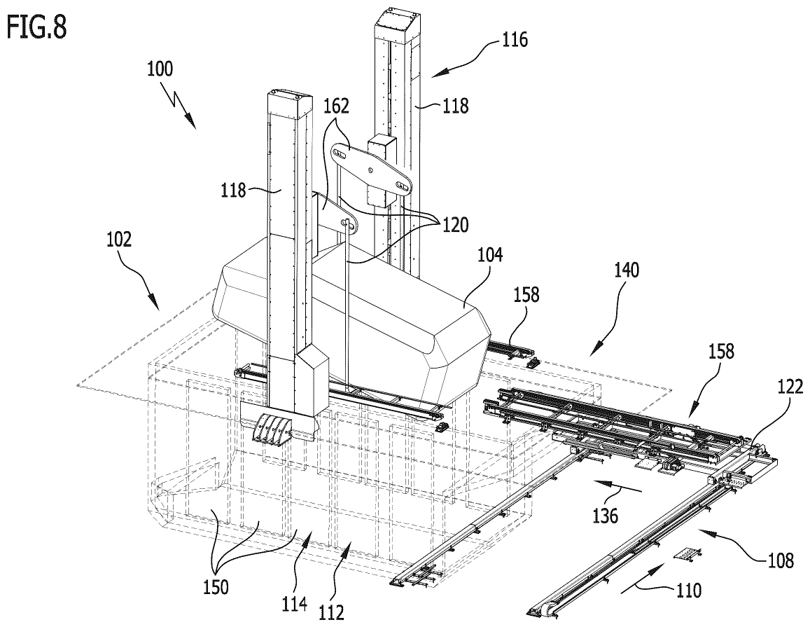

As can be seen in particular from a comparison of FIGS. 7 and 8, the chain conveying device 158, which is associated with the lifting device 116, is designed in two parts, wherein the two parts, which each comprise a chain of the chain conveying device 158, are displaceable relative to one another, in particular can be moved apart and can be moved towards one another.

The two parts of the chain conveying device 158 thus replace the rows 148 of carrying units 146 of the third embodiment of the treatment system 100 shown in FIGS. 1 to 3.

In particular, the two parts of the chain conveying device 158, which are associated with the lifting device 116, can be brought into a release position (see FIG. 8) and into a carrying position (see FIG. 7).

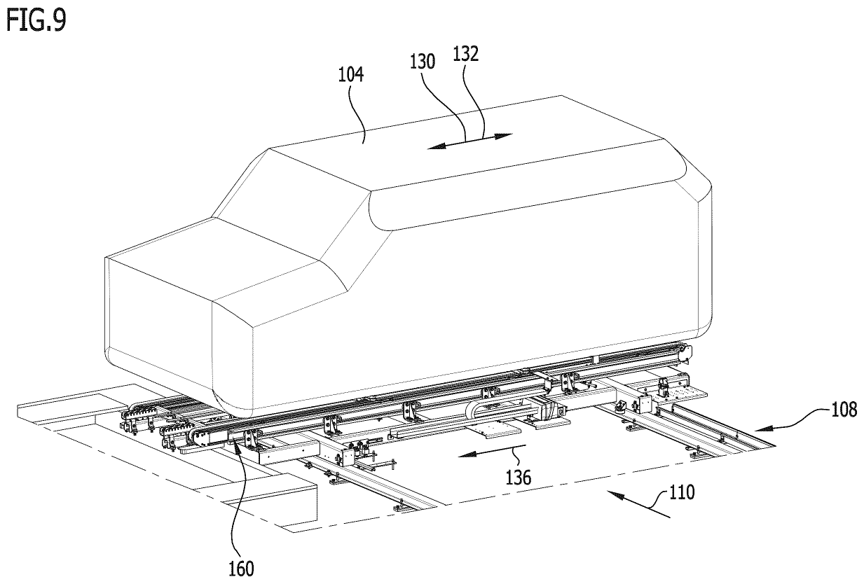

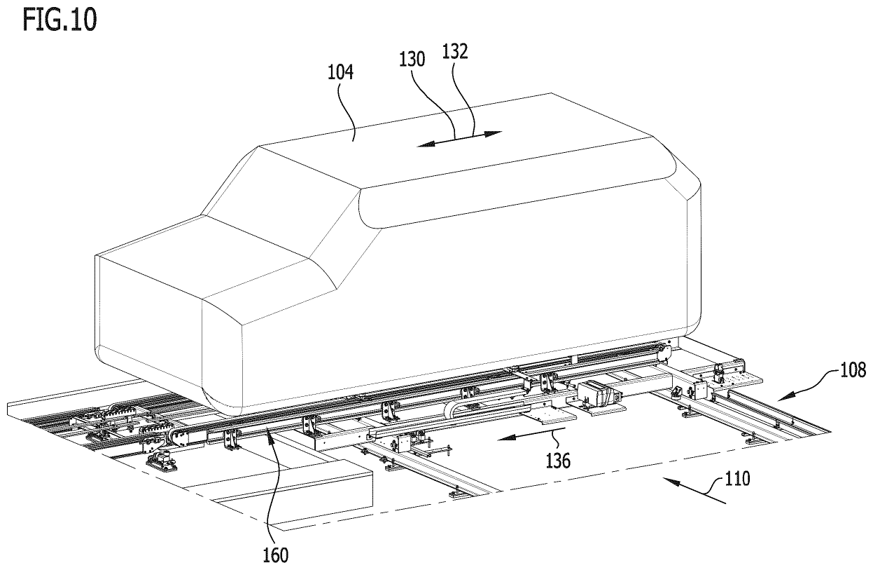

As can be seen in particular from a comparison of FIGS. 9 and 10, the chain conveying device 158 associated with the main conveying device 108 can be moved relative to the carriage 122.

In particular, the carriage 122 comprises a telescopic device 160 by means of which the chain conveying device 158 can be extended.

By means of the telescopic device 160, in particular an initially existing gap or distance between the two chain conveying devices 158 of the transfer device 140 can be overcome in order to ultimately ensure an unhindered transfer of the workpieces 104 from the main conveying device 108 to the lifting device 116 or from the lifting device 116 to the main conveying device 108.

As can also be seen from FIG. 8, it may be provided that the lifting elements 120 are arranged on the respective lifting unit 118 by means of a swivel device 162.

In particular, this can enable the workpiece 104 to be tilted when it is introduced into or removed from the fluid container 112, for example to avoid bubbles from forming and thus impairing the coating process.

In all other respects, the fifth embodiment of the treatment system 100 shown in FIGS. 7 to 10 corresponds to the embodiment shown in FIGS. 1 to 3 in terms of design and function, so that reference is made in this respect to their description above.

With further embodiments of the treatment system 100 (not shown), a combination of various elements of the embodiments described may also be provided. For example, instead of the two lifting units 118 according to the fifth embodiment shown in FIGS. 7 to 10, a suspension device 152 according to the fourth embodiment shown in FIG. 6 may be provided.

Furthermore, it is apparent to the person skilled in the art from the above that numerous features described in connection with the treatment system 100 are also relevant for the conveying system 142, in particular independently of the actual treatment of the workpieces 104.

### LIST OF REFERENCE SIGNS

100 Treatment system
102 Treatment station
104 Workpiece
106 Vehicle body
108 Main conveying device
110 Main conveying direction
112 Fluid container
114 Immersion tank
116 Lifting device
118 Lifting unit
120 Lifting element
122 Carriage
124 Workpiece carrier
125 Drip tray
126 Skid
128 Roller conveying device
130 Transverse direction
132 Longitudinal direction
134 Transverse conveying device
136 Transfer direction
140 Transfer device
142 Conveying system
144 Conveying device portion
146 Carrying unit
148 Row
150 Electrode
152 Suspension device
154 Holding frame
156 Belt
158 Chain conveying device
160 Telescopic device
162 Swivel device

1. A conveying system for conveying workpieces, optionally vehicle bodies, wherein the conveying system comprising:
a main conveying device for conveying the workpieces along a main conveying direction;
a lifting device by which the workpieces can be raised and/or lowered, optionally lowered into a treatment position, at a position arranged laterally offset next to the main conveyor device; and
a transfer device by which the workpieces can be transferred from the main conveying device to the lifting device and/or from the lifting device to the main conveying device in a transfer direction extending transversely to the main conveying direction.

2. The conveying system according to claim 1, wherein the main conveying device is a transverse conveying device by which the workpieces can be conveyed in a transverse alignment, wherein the workpieces are oriented in the transverse alignment such that a longitudinal direction, optionally a longitudinal axis, of the workpieces is aligned transversely, in particular optionally at least approximately perpendicularly, to the main conveying direction and/or at least approximately horizontally.

3. The conveying system according to claim 1, wherein
a) the main conveying device is a chain conveying device or a roller conveying device, or wherein the main conveying device includes a chain conveying device and/or a roller conveying device; and/or
b) the transfer device is a chain conveying device or a roller conveying device, or wherein the transfer device includes a chain conveying device and/or a roller conveying device.

4. The conveying system according to claim 1 to 3, characterized in that, wherein the conveying system includes a plurality of lifting devices arranged in succession along the main conveying direction by which the workpieces can be raised and/or lowered at a plurality of positions arranged laterally offset next to the main conveying device, optionally can be lowered into a plurality of treatment positions that are different from one another.

5. The conveying system according to claim 1, wherein the transfer device includes one or more carrying units onto which the workpieces can be placed directly or indirectly, optionally by a workpiece carrier, for example by a traverse and/or a skid, for example by horizontally displacing the workpiece starting from the main conveying device.

6. The conveying system according to claim 5, wherein one or more of the carrying units are movable, optionally linearly displaceable in a direction extending transversely to the transfer direction.

7. The conveying system according to claim 5, wherein the transfer device includes a plurality of carrying units, optionally two rows of carrying units, which can be moved towards one another to reach a carrying position of the carrying units and which can be moved away from one another to reach a release position.

8. The conveying system according to claim 5, wherein the treatment position, into which the workpieces can be lowered by the lifting device, is arranged below the one or more carrying units of the transfer device with respect to the direction of gravity.

9. A treatment system for treating workpieces, in particular vehicle bodies, wherein the treatment system includes a conveying system according to claim 1.

10. The treatment system according to claim 9, wherein the treatment system includes one or more treatment stations, wherein an immersion tank is arranged at each treatment station, into which the workpieces can be immersed by one or more lifting devices of the conveying system.

11. The treatment system according to claim 9, wherein the one or more immersion tanks, optionally all of the immersion tanks, are arranged below a conveying level at which the workpieces can be conveyed along the main conveying direction by the main conveying device.

12. The treatment system according to claim 9, wherein
a) one or more of the treatment stations, optionally all of the treatment stations, are electro dip coating stations; and/or
b) one or more of the treatment stations, optionally all of the treatment stations, are accessible only on one side and/or starting from the main conveying device in order to feed and discharge workpieces.

13. A method for treating workpieces, in particular, optionally vehicle bodies, the method comprising:
conveying the workpieces by a main conveying device along a main conveying direction;
transferring the workpieces by a transfer device in a transfer direction extending transversely to the main conveying direction from the main conveying device to a lifting device and/or from the lifting device to the main conveying device; and
raising and/or lowering the workpieces by a lifting device at a position arranged laterally offset next to the main conveying device, wherein the workpieces are optionally lowered into a treatment position.

14. The method according to claim 13, wherein, for transferring the workpieces, the workpieces are picked up directly or indirectly by one or more carrying units of the transfer device and made available to the lifting device, and wherein the one or more carrying units are moved away by the lifting device after the respective workpiece has been picked up, optionally moved out of a lifting path of the respective workpiece arranged below the workpiece.

15. The method according to claim 13, wherein the workpieces are moved in a transverse alignment thereof along the main conveying direction and in a longitudinal alignment thereof along the transfer direction.
